(19) United States
(12) Patent Application Publication
(10) Pub. No.: US 2017/0014928 A1
(43) Pub. Date: Jan. 19, 2017

(54) Electrode Wire for Electric Discharge Machining and Method for Manufacturing the Electrode Wire

(71) Applicant: YUANG HSIAN METAL INDUSTRIAL CORP., Changhua City (TW)

(72) Inventor: Kuo-Ta Chang, Changhua City (TW)

(21) Appl. No.: 14/798,521

(22) Filed: Jul. 14, 2015

(51) Int. Cl. B23H 7/24; C22F 1/08; C22C 9/04

(52) U.S. Cl. CPC B23H 7/24; C22C 9/04; C22F 1/08

(57) ABSTRACT

A method for manufacturing an electrode wire (1) includes melting and mixing copper with a content of 60% by weight and zinc with a content of 40% by weight to form a copper/zinc binary eutectic, heat solidifying the copper/zinc binary eutectic to form a full beta (β) phase alloy (10), galvanizing the full beta (β) phase alloy, processing the full beta (β) phase alloy by a low-temperature heat treatment, prolonging the treating time of the low-temperature heat treatment to form a surface electric layer, and heat solidifying the surface electric layer to form a solid alloy layer (11) on the surface of the full beta (β) phase alloy and to let the solid alloy layer form a gamma (γ) phase, an epsilon (ε) phase or an eta (η) phase at different reaction temperatures. Thus, the electrode wire only needs one working procedure.

### BACKGROUND OF THE INVENTION

1. Field of the Invention

The present invention relates to an electrode wire and, more particularly, to an electrode wire for an electric discharge machining (EDM) process and a method for manufacturing the electrode wire.

2. Description of the Related Art

A first conventional electrode wire (U.S. Pat. No. 8,067,689) in accordance with the prior art shown in FIG. 3 comprises a copper metallic wire 12, a first electroplated layer 18 coated on an outer surface of the copper metallic wire 12, and a second electroplated layer 15 coated on an outer surface of the first electroplated layer 18. The first electroplated layer 18 is a brass coating. The second electroplated layer 15 is a zinc coating. The first electroplated layer 18 is a copper/zinc solid solution. In fabrication, the copper metallic wire 12 with an alpha (α) phase is initially galvanized (electroplated by zinc) and then processed by a heat treatment to form the first electroplated layer 18 with a beta (β) phase. Then, the first electroplated layer 18 with a beta (β) phase is initially galvanized (electroplated by zinc) and then processed by a heat treatment to form the second electroplated layer 15 with a gamma (γ) phase. Thus, the conventional electrode wire contains the gamma (γ) phase by a first electroplating, a first heat treatment, a second electroplating and a second heat treatment. However, the conventional electrode wire needs two electroplating/heat treatment procedures to reach the gamma (γ) phase (that is, α+Zn→β, and β+Zn→γ), thereby complicating the manufacturing process, elongating the working procedure and time, and increasing the cost of fabrication. In addition, the conventional electrode wire needs two electroplating/heat treatment procedures, so that the conventional electrode wire has a greater surface roughness and cannot be cut precisely. Further, when the conventional electrode wire is cut, the second electroplated layer 15 easily drops powder.

A second conventional electrode wire 3 (U.S. Pat. No. 6,447,930) in accordance with the prior art shown in FIGS. 4 and 5 comprises a core 31 and a sheath layer 32 coated on an outer surface of the core 31. The core 31 is a brass with an alpha (α) phase (α-Ms). The sheath layer 32 is a zinc or zinc alloy with an eta (η) phase (η-Zn). Thus, the conventional electrode wire 3 contains the gamma (γ) phase by a first electroplating, a first heat treatment, a second electroplating and a second heat treatment. However, the conventional electrode wire 3 needs two electroplating/heat treatment procedures to reach the gamma (γ) phase (that is, α+Zn→β, and β+Zn→γ), thereby increasing the cost of fabrication. In addition, the second conventional electrode wire 3 needs two electroplating/heat treatment procedures, so that the second conventional electrode wire 3 has a greater surface roughness and cannot be cut precisely.

A third conventional electrode wire 4 (E.P. Patent No. 0733431) in accordance with the prior art shown in FIGS. 6 and 7 comprises a core 41 and a sheath layer 42 coated on an outer surface of the core 41. The core 41 is a brass with an alpha (α) phase (α-Ms). The sheath layer 42 is a zinc or zinc alloy with an eta (η) phase (η-Zn). Thus, the conventional electrode wire 3 contains the gamma (γ) phase by a first electroplating, a first heat treatment, a second electroplating and a second heat treatment. However, the conventional electrode wire 4 needs two electroplating/heat treatment procedures to reach the gamma (γ) phase (that is, α+Zn→β, and β+Zn→γ), thereby increasing the cost of fabrication. In addition, the third conventional electrode wire 4 needs two electroplating/heat treatment procedures, so that the third conventional electrode wire 4 has a greater surface roughness and cannot be cut precisely.

### BRIEF SUMMARY OF THE INVENTION

In accordance with the present invention, there is provided a method for manufacturing an electrode wire, comprising a first step of melting and mixing a copper with a content of 60% by weight and a zinc with a content of 40% by weight to form a copper/zinc binary eutectic which is disposed at a liquid phase, a second step of heat solidifying the copper/zinc binary eutectic to solidify the copper/zinc binary eutectic from the liquid phase into a full beta (β) phase alloy which is disposed at a solid solution phase, a third step of galvanizing the full beta (β) phase alloy which functions as a metallic core, a fourth step of processing the metallic core of the full beta (β) phase alloy by a low-temperature heat treatment to form a coating layer on a surface of the full beta (β) phase alloy, a fifth step of prolonging a treating time of the low-temperature heat treatment to let the surface of the full beta (β) phase alloy and the coating layer produce a mutual solution to form a surface electric layer, and a sixth step of heat solidifying the surface electric layer to form a solid alloy layer on the surface of the full beta (β) phase alloy and to let the solid alloy layer form a gamma (γ) phase, an epsilon (ε) phase or an eta (η) phase at different reaction temperatures so as to form an electrode wire including the full beta (β) phase alloy and the solid alloy layer.

According to the primary advantage of the present invention, the full beta (β) phase alloy functions as a metallic core that is directly galvanized and processed by a low-temperature heat treatment whose working time is prolonged to form the electrode wire with the gamma (γ) phase, the epsilon (ε) phase or the eta (η) phase at different reaction temperatures during different periods of time, so that the electrode wire only needs one working procedure (only a single electroplating/heat treatment process), without needing two working procedures, thereby simplifying the manufacturing process and shortening the working procedure and time, and thereby decreasing the cost of fabrication.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a cross-sectional view of an electrode wire in accordance with the preferred embodiment of the present invention.

FIG. 2 is an equilibrium phase diagram of copper (Cu) and zinc (Zn) in accordance with the preferred embodiment of the present invention.

FIG. 3 is a cross-sectional view of a first conventional electrode wire in accordance with the prior art.

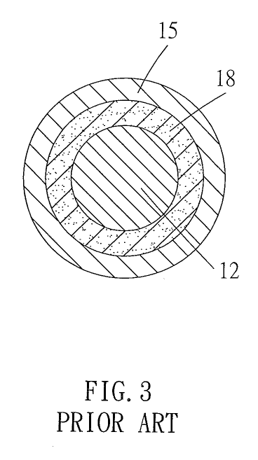

FIG. 4 is a cross-sectional view of a second conventional electrode wire in accordance with the prior art.

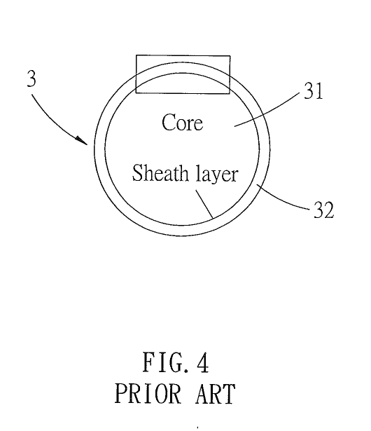

FIG. 5 is a cross-sectional view of the second conventional electrode wire as shown in FIG. 4.

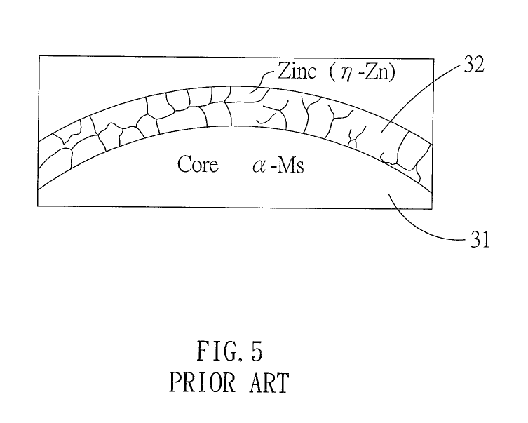

FIG. 6 is a front view of a third conventional electrode wire in accordance with the prior art.

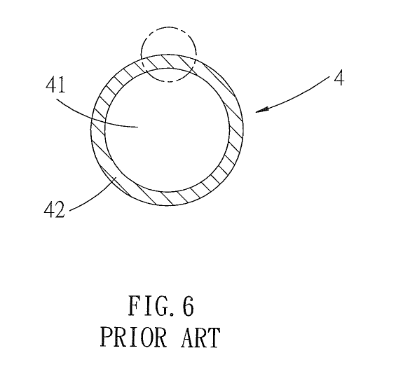

FIG. 7 is a cross-sectional view of the third conventional electrode wire as shown in FIG. 6.

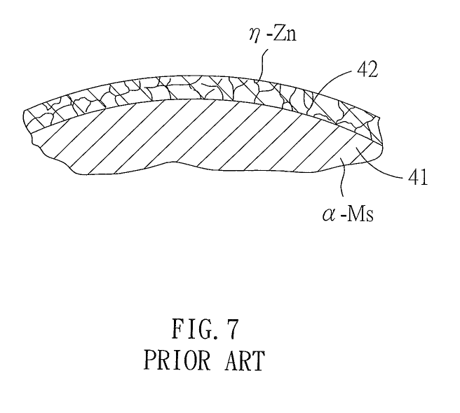

### DETAILED DESCRIPTION OF THE INVENTION

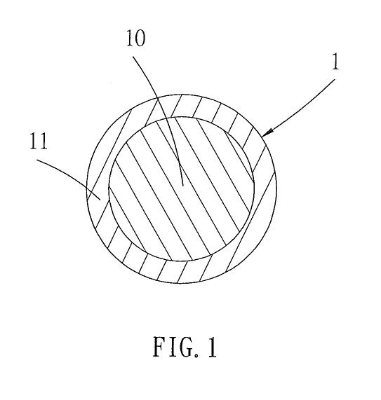

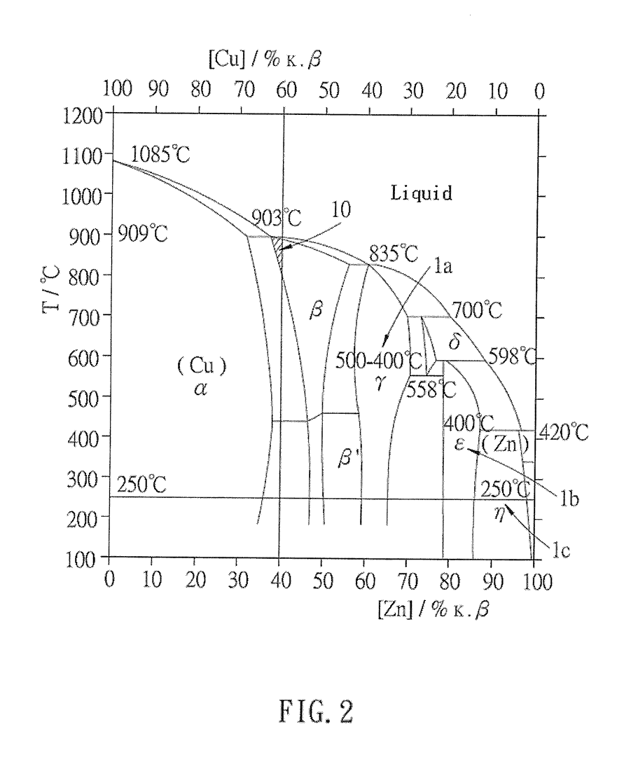

Referring to FIGS. 1 and 2, an electrode wire 1 for an electric discharge machining (EDM) process in accordance with the preferred embodiment of the present invention comprises a full beta (β) phase alloy 10, and a solid alloy layer 11 disposed on an outer surface of the full beta (β) phase alloy 10. The full beta (β) phase alloy 10 functions as a metallic core and includes copper with a content of 60% by weight and zinc with a content of 40% by weight. The electrode wire 1 is a metallic alloy wire.

A method for manufacturing the electrode wire 1 in accordance with the preferred embodiment of the present invention comprises a first step of melting and mixing a copper with a content of 60% by weight and a zinc with a content of 40% by weight to form a copper/zinc binary eutectic which is disposed at a liquid phase, a second step of heat solidifying the copper/zinc binary eutectic to solidify the copper/zinc binary eutectic from the liquid phase into a full beta (β) phase alloy 10 which is disposed at a solid solution phase, a third step of galvanizing the full beta (β) phase alloy 10 which functions as a metallic core, a fourth step of processing the metallic core of the full beta (β) phase alloy 10 by a low-temperature heat treatment to form a coating layer on a surface of the full beta (β) phase alloy 10, a fifth step of prolonging a treating time of the low-temperature heat treatment to let the surface of the full beta (β) phase alloy 10 and the coating layer produce a mutual solution to form a surface electric layer, and a sixth step of heat solidifying the surface electric layer to form a solid alloy layer 11 on the surface of the full beta (β) phase alloy 10 and to let the solid alloy layer 11 form a gamma (γ) phase, an epsilon (ε) phase or an eta (η) phase at different reaction temperatures so as to form the electrode wire 1 including the full beta (β) phase alloy 10 and the solid alloy layer 11.

In the first step, the copper of 60% and the zinc of 40% are melted into a liquid phase at a melting temperature of about 909° C. Thus, the copper at a liquid phase and the zinc at a liquid phase are mixed and dissolved mutually to form the full beta (β) phase alloy 10. In the second step, the copper/zinc binary eutectic of the full beta (β) phase alloy 10 is directly heat solidified at a melting point in the range of 903° C. to 900° C. (see FIG. 2). In the fourth step, the low-temperature heat treatment has a reaction temperature that is controlled to be lower than 250° C. (see FIG. 2). Thus, the electrode wire 1 made by the method of the present invention has a smaller surface roughness, can be cut rapidly, will not drop powder and has a better adhesive force.

As shown in FIG. 2, an equilibrium phase diagram of copper (Cu) and zinc (Zn) is shown, wherein the vertical axis indicates the temperature (° C.), the upper horizontal axis indicates the weight content of the copper (Cu), and the upper horizontal axis indicates the weight content of the zinc (Zn). When the content of the copper is 60% and the content of the zinc is 40%, the copper/zinc binary eutectic is heat solidified to form the full beta (β) phase alloy 10. In the low-temperature (about 250° C.) heat treatment of the full beta (β) phase alloy 10, the full beta (β) phase alloy 10 of the copper/zinc binary eutectic is disposed at an equilibrium phase to let the solid alloy layer 11 form the gamma (γ) phase, the epsilon (ε) phase or the eta (η) phase at the different reaction temperatures during different periods of time.

When the reaction temperature of the low-temperature heat treatment of the full beta (β) phase alloy 10 is controlled to be under 835° C. (see FIG. 2), the solid alloy layer 11 forms the gamma (γ) phase. When the reaction temperature of the low-temperature heat treatment of the full beta (β) phase alloy 10 is controlled to be under 600° C. (see FIG. 2), the solid alloy layer 11 forms the epsilon (ε) phase. When the reaction temperature of the low-temperature heat treatment of the full beta (β) phase alloy 10 is controlled to be under 420° C. (see FIG. 2), the solid alloy layer 11 forms the eta (η) phase.

The electrode wire 1 in accordance with the preferred embodiment of the present invention has a workpiece Surface Roughness (Ra) that is described in the following table.

| Phase, | Surface Roughness, | CUTTING SPEED |
|---|---|---|
| η (Eta): | Ra <0.10, | >20% higher than |
| | | 60/40 Brass Wire |
| ε (Epsilon): | Ra <0.05, | |
| γ (Gamma): | Ra <0.05 (surface | |
| | better than ε Phase) | |

When the reaction temperature of the low-temperature heat treatment of the full beta (β) phase alloy 10 (in the phase of β+γ) is controlled optimally in the range of 500° C. to 400° C., the electrode wire 1 with the gamma (γ) phase is indicated by a copper/zinc alloy material 1a (see FIG. 2) which has a surface roughness smaller than 0.05 (Ra<0.05), which belongs to a precise rapid cutting. When the reaction temperature of the low-temperature heat treatment of the full beta (β) phase alloy 10 (in the phase of β+γ) is controlled optimally at 400° C., the electrode wire 1 with the epsilon (ε) phase is indicated by a copper/zinc alloy material 1b (see FIG. 2) which has a surface roughness smaller than 0.05 (Ra<0.05), which belongs to a common precise cutting. When the reaction temperature of the low-temperature heat treatment of the full beta (β) phase alloy 10 (in the phase of (β+γ) is controlled optimally at 250° C., the electrode wire 1 with the eta (η) phase is indicated by a copper/zinc alloy material 1c (see FIG. 2) which has a surface roughness smaller than 0.10 (Ra<0.10), which belongs to a precise rapid cutting without dropping powder.

Accordingly, the full beta (β) phase alloy 10 functions as a metallic core that is directly galvanized and processed by a low-temperature heat treatment whose working time is prolonged to form the electrode wire 1 with the gamma (γ) phase, the epsilon (ε) phase or the eta (η) phase at different reaction temperatures during different periods of time, so that the electrode wire 1 only needs one working procedure (only a single electroplating/heat treatment process), without needing two working procedures, thereby simplifying the manufacturing process and shortening the working procedure and time, and thereby decreasing the cost of fabrication. In addition, the electrode wire 1 does not need a secondary working procedure to apply an electroplated layer on the outer surface thereof, so that the electrode wire 1 has a smaller surface roughness, can be cut rapidly and precisely, will not drop powder and has a better adhesive force.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A method for manufacturing an electrode wire, comprising:
a first step of melting and mixing a copper with a content of 60% by weight and a zinc with a content of 40% by weight to form a copper/zinc binary eutectic which is disposed at a liquid phase;
a second step of heat solidifying the copper/zinc binary eutectic to solidify the copper/zinc binary eutectic from the liquid phase into a full beta (β) phase alloy which is disposed at a solid solution phase;
a third step of galvanizing the full beta (β) phase alloy which functions as a metallic core;
a fourth step of processing the metallic core of the full beta (β) phase alloy by a low-temperature heat treatment to form a coating layer on a surface of the full beta (β) phase alloy;
a fifth step of prolonging a treating time of the low-temperature heat treatment to let the surface of the full beta (β) phase alloy and the coating layer produce a mutual solution to form a surface electric layer; and
a sixth step of heat solidifying the surface electric layer to form a solid alloy layer on the surface of the full beta (β) phase alloy and to let the solid alloy layer form a gamma (γ) phase, an epsilon (ε) phase or an eta (η) phase at different reaction temperatures so as to form an electrode wire including the full beta (β) phase alloy and the solid alloy layer.

2. The method of claim 1, wherein in the low-temperature heat treatment of the full beta (β) phase alloy, the full beta (β) phase alloy of the copper/zinc binary eutectic is disposed at an equilibrium phase to let the solid alloy layer form the gamma (γ) phase, the epsilon (ε) phase or the eta (η) phase at the different reaction temperatures during different periods of time.

3. The method of claim 1, wherein in the second step, the copper/zinc binary eutectic of the full beta (β) phase alloy is directly heat solidified at a melting point in the range of 903° C. to 900° C.

4. The method of claim 1, wherein in the fourth step, the low-temperature heat treatment has a reaction temperature that is controlled to be lower than 250° C.

5. The method of claim 1, wherein:
when the reaction temperature of the low-temperature heat treatment of the full beta (β) phase alloy is controlled to be under 835° C., the solid alloy layer forms the gamma (γ) phase;
when the reaction temperature of the low-temperature heat treatment of the full beta (β) phase alloy is controlled to be under 600° C., the solid alloy layer forms the epsilon (ε) phase; and
when the reaction temperature of the low-temperature heat treatment of the full beta (β) phase alloy is controlled to be under 420° C., the solid alloy layer forms the eta (η) phase.

6. The method of claim 1, wherein:
when the reaction temperature of the low-temperature heat treatment is controlled in the range of 500° C. to 400° C., the full beta (β) phase alloy (in the phase of β+γ) directly forms a copper/zinc alloy material of the electrode wire of the gamma (γ) phase, which has a surface roughness smaller than 0.05 (Ra<0.05);
when the reaction temperature of the low-temperature heat treatment is controlled in the range of 400° C., the full beta (β) phase alloy (in the phase of β+γ) directly forms a copper/zinc alloy material of the electrode wire of the epsilon (ε) phase, which has a surface roughness smaller than 0.05 (Ra<0.05); and
when the reaction temperature of the low-temperature heat treatment is controlled in the range of 250° C., the full beta (β) phase alloy (in the phase of β+γ) directly forms a copper/zinc alloy material of the electrode wire of the eta (η) phase, which has a surface roughness smaller than 0.10 (Ra<0.10).
